(19) United States
(12) Patent Application Publication
(10) Pub. No.: US 2009/0254446 A1
(43) Pub. Date: Oct. 8, 2009

(54) Household shopping programming assistant system and methods

(76) Inventor: Valentin Chernyak, Edison, NJ (US)

Correspondence Address: Valentin Chernyak, 19 Clive Hills Rd, Edison, NJ, 08820, US

(21) Appl. No.: 12/384,123

(22) Filed: Apr. 1, 2009

Related U.S. Application Data
(60) Provisional application No. 61/072,795, filed on Apr. 3, 2008.

(51) Int. Cl. G06Q 30/00; H04W 4/00

(52) U.S. Cl. 705/26; 705/27; 455/466

(57) ABSTRACT

Household shopping assistant system that stores the individual household purchasing requests and preferences in a centralized server with a data base and allows for shopping list retrieval via mobile phone web access and/or via SMS messaging. A method of storing individual purchasing requests and preferences and selective delivery to the shopper's mobile phone(s) and PDA(s). A method for optimizing the shopping list based on product attributes, availability of said products in stores, location of said products within said stores and driving distance between said stores.

This application claims the benefit of provisional application Ser. No. 61/072,795 filed Apr. 3, 2008

### FIELD OF INVENTION

The present invention relates to the household shopping systems and methods via mobile phone and/or PDA (Personal Digital Assistant).

### BACKGROUND OF INVENTION

Many large households deal with the problem of shopping with a few handwritten shopping lists that contain requests from different household members. Usually those shopping lists are not full, require manual aggregation and do not help to plan out the shopping trip.

In many cases handwritten shopping lists are lost, ripped, or left at home.

Shoppers with mobile phones usually have to call home to confirm whether a particular product needs to be purchased.

The products that are not bought during a particular shopping trip need to be written into a new shopping list, which causes errors and conflicts.

It is known in the art the household shopping system (see U.S. Pat. No. 7,249,708). The referenced patent describes but does not provide any ways to propagate the shopping list over the mobile phone via web access or via SMS (Short Message Service).

Another known published patent application 2008/0005168 describes the generic household computer network but also does not allow for a shopping list to be transferred between the home network and mobile phones and/or PDAs.

Similarly the U.S. Pat. No. 5,544,040 describes the “system for preparing a list of food items to be purchased”, but does not provide a way to distribute the shopping lists over SMS and/or via email or WWW (World Wide Web).

Accordingly, there is a need in the art for a system and method that makes it possible to keep the full database with the household-oriented information on household members, stores, store departments and products.

### SUMMARY OF INVENTION

The present invention provides the computer system that makes it possible to keep the full database with the household-oriented information on household members, stores, store departments and products.

The system also allows keeping track of the product orders and getting the optimized shopping lists on the shopper's mobile phone and/or PDA.

The system automatically aggregates data from the individual household member's requests, sorts them by stores and departments and sends the aggregated lists to mobile phone(s) or printer(s) upon request.

Using the system any shopper with a mobile phone can always get the latest “hot” relevant version of the shopping list and mark down the product(s) that were just bought.

The system drastically improves the shopping experience, especially for the recurring items, such as food, house supplies, and small business management items.

The new method of shopping (mobile phone based approach) allows for the elimination of paper shopping lists, simplifies the ordering of products, saves time and eliminates errors.

The invention provides a way to share household's shopping preferences (such as store names, products, sale prices and such) in a central database so that these preferences can be used to create an aggregated household shopping list.

The above mentioned shopping list can be later retrieved from the central computer via web access, PDA web access, SMS, email or it can be printed on a regular printer.

The invention allows a household shopper with a mobile phone or a PDA to retrieve the latest relevant shopping list from the central computer and mark the purchased products so that the purchasing history gets reflected in the same central computer.

The invention allows the shoppers to automatically mark the locations where the particular products were bought so, that the central computer's data base can automatically match this location to one of the existing (or new) stores.

The location determination may be processed via the device GPS component (Blackberry, iPod, etc.) or manually entered by the shopper.

The invention makes it possible to use the PDA or mobile phone voice generation and voice recognition features to read the shopping list(s) aloud as well as accept voice commands to alter the shopping list and mark products.

The invention provides a new way of shopping—acting with the relevant shopping list, delivered to the shopper's mobile phone or PDA via web access or SMS.

This brings the totally new shopping experience as the data get delivered from the central computer to the mobile phone or PDA and allows for the purchase information to be sent from the mobile phone or PDA to the central computer.

It is to be understood, that both the foregoing general description and the following detailed description are exemplary and explanatory and are intended to provide further explanation of the invention as claimed.

### BRIEF DESCRIPTION OF THE DRAWINGS

FIG. 1 is a schematic illustration of a household management system according to one embodiment of the present invention.

FIG. 2 is a schematic illustration of Central computer and supplementary computers overview.

### DETAILED DESCRIPTION OF THE INVENTION

The present invention provides computer-implemented household management systems and methods. Some embodiments allow consumers to utilize their own personal shopping histories for a variety of purposes, such as generating shopping lists.

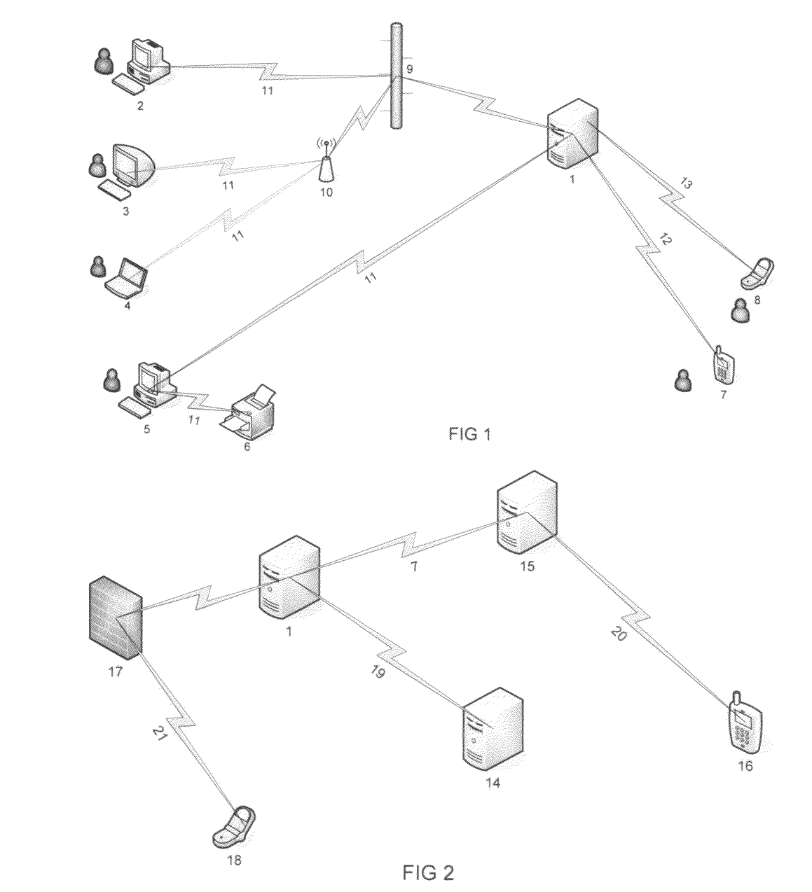

FIG. 1 depicts an exemplary embodiment of a household shopping assistant system according to the present invention, wherein the household's shopping information and purchase histories are stored on the portal's central computer 1. The household shopping assistant system comprises 1—central computer (for example DELL[tm] Server), 2—household member's computers (for example IBM[tm] PC), 3—household member's computer (for example MAC[tm]), 4—household member's laptop (for example Dell [tm] or Lenovo[tm]), 5—household shopper's PC, connected for example to a LAN [tm] printer, 6—local or network printer, 7—household shopper with a PDA, 8—household shopper with a mobile phone, 9—ethernet connector (for example Linksys [tm]router), 10—wireless access Point (for example Linksys [tm] WAP), 11—internet connection (for example CAT5 [tm] cable and/or wireless), 12—wireless access from PDA (for example IXEV[tm], 3G), 13—wireless access from mobile phone (IXEV, 3G, SMS)

The household's individual computers 2,3,4,5 are connected to the central computer 1 via the Internet WWW communication. One or more computers are connected to the local printer(s) 6. The household's computers are organized into the a home local area network (LAN) via ethernet connector(s) 9, and/or wireless access points (WAP(s)) 10, and communication cables 11. The household's shoppers 7,8 may query the shopping list via the mobile phones and/or PDA(s) that are connected to the central computer via PDA wireless access 12 and/or mobile phone wireless access 13.

As used herein, the term “personal computer” (or “PC”) refers to a computer associated with a particular user or a particular user's household, rather than a centralized server or other computer system which processes or stores data for a plurality of users or households. However, the term “personal computer” is not limited to traditional desktop computers. Rather, “personal computer” generally includes any computing device having a CPU, memory, a visual display device (e.g., a display screen, a printer, etc.), and an input device (e.g., a keyboard, mouse, touch sensitive screen, etc,).

By way of example, a personal computer may include a desktop PC, a notebook PC, a tablet PC, a personal digital assistant (PDA), a wireless computing device such as a mobile phone or automobile computer, an interactive TV, an Internet appliance, or the like.

FIG. 2 depicts the structure of the set of central computers, joined into portal Local Area Network (LAN). The Local Area Network comprises: 1—central computer (DELL Server), 14—DATA server (for example DELL server with MS SQL Server), 15—Mobile phone or PDA (for example Blackberry, Smartphone, etc), 16—Mobile phone or PDA (for example Smartphone, Blackberry, Motorolla, etc), 17—Portal Firewall (for example Linksys), 18—Web access (wireless web access) 19—Ethernet connection (CAT5 cable), 20—Wireless phone communication (SMS service from Cingular or Verizon)

Central computer(s) 1 is(are) connected to a data base server(s) 14 via ethernet connection cables 19 and are protected from the internet via the firewall 17.

Household's shoppers use PDA(S) and mobile phone(s) 18 that gain access to the central computer 1 via the web access through the firewall 17.

Other household's shoppers 16 use their mobile phone(s) that use the SMS services that are getting data directly from the central computer via the SMS gateway.

The invention comprises a:

central computer (Dell) with the Microsoft Web Server (IIS), located for example at the internet portal (http://www.adhocshop.com/) connected to the SQL data base (SQL2000), exposed to the internet

MS SQL database capable of keeping information on household accounts, household users within an account, as well as the information about stores, departments, products and purchasing history for each of the products.

Portal software that allows household users who are connected to the internet to manipulate the household information (add, delete, edit and rearrange stores, departments, products, users) as well as add particular products to the shopping list.

The software keeps track of the requested products, organizes these orders into shopping lists and makes it possible to print these shopping lists on the household printer(s) as well as distribute them via mobile phone and/or PDA WEB access and/or SMS and/or EMAIL.

Household computers—desktops and laptops (such as Dell, Lenovo, IBM PC, Macintosh) are connected to the portal web server via the Internet connection.

A household with 4 members that owns three home computers—Dell, HP and Lenovo laptop. Each member of the household will create their own account in our system and will have his/her own user id and password to log onto the portal, but all 4 accounts will be associated with the single household

Security settings associated with each household member's account will determine whether they will be able to add/edit/delete products and stores to the household account, add any products to the shopping list, or be limited to viewing the shopping list created by other household members.

The aggregate shopping list (comprising all the entries from all the participated household members) will be kept indefinitely on the server and will be available for printing and/or propagation via SMS, EMAIL or WEB access from a mobile phone or PDA.

Multiple household members will be able to access the aggregate shopping list at the same time via their mobile phone(s) and/or PDA(s). The shopping list will be optimized to display the minimum number of stores at which all of the requested products can be bought, wherein the store with the most products will be displayed first and the remainder of the stores will be sequenced in a way that minimizes drive time between them. Products within a store will be grouped according to the layout of that individual store's departments. The shopper can re-optimize the shopping list by specifying which store they are heading to. The shopping list will then list at the top all the products that can be bought in that one store, and spread the remaining products among the minimal number of other stores.

Once in the store, each household member will be able to check off the products from the shopping list in real time as they are being bought. All other members of the household will no longer see bought products on the shopping list. The tool can be configured to prevent household members from adding bought products back into the shopping list for a said period of time to prevent duplicate requests. Household members can view previous purchase history to assist them in efficiently making future requests

Household members will be able to take advantage of a social networking site to share information and about products and stores with other shoppers which may or may not be part of their household. They will be able to make bulletin board postings, engage in chats or simply rate their products and stores. Household members will also be able to import individual products or entire stores complete from other members of the social networks into their accounts.

Having thus described a preferred embodiment, it should be apparent to those skilled in the art that certain advantages of the described method and apparatus have been achieved. It should also be appreciated that various modifications, adaptations and alternative embodiments thereof may be made within the scope and spirit of the present invention. The invention is further defined by the following claims.

What is claimed is:

1. A household purchasing and preferences management system, comprising:
(a) a households data store of individual accounts for members of a household;
(b) a retailers data store of store information comprising addresses, phones, hours of operation, departments and layout of those departments within stores;
(c) a products data store comprising descriptions, units of measure, sale prices, and other user-defined attributes of individual products, as well as a link to the retailers data store which specifies at which stores the product can be purchased;
(d) a shopping lists data store comprising transactional information about requests for products made by household members
(e) a purchase history data store comprising transactional information about purchases of said products made by said household members at said retailers

2. The system of claim 1, further comprising mobile internet accessible interface module in communication with said retailer data store and said product data store for changing any information on the listed retailers, departments and products.

3. The system of claim 1, further comprising mobile internet accessible interface module in communication with said data store for adding products to the shopping list online (ordering of products), which can be done by multiple household members simultaneously.

4. A method for continuously forming and publishing an aggregate shopping list online, comprising:
(a) selecting selected products from a product data store
(b) selecting retailers from a retail data store where the said products are available for sale
(c) selecting the member of the household making the request from a household data store
(d) selecting previous purchase history date for the requested product from a purchase data store
(e) publishing the aggregate shopping list online and making it available to-any shoppers via methods selected from the group consisting of mobile phone(s), web access, SMS, Email or Print.

5. The method of claim 4 further comprising accessing the shopping list via a mobile device browser comprising and
a) interactively accessing the shopping list
b) checking purchased products off directly on said shopping list
c) recording said information in the purchasing history data store

6. The method of claim 4 further comprising the step of interactively requesting the central computer to send an SMS with the aggregate shopping list to a requesting phone.

7. A computer implemented method comprising
(a) identifying previous purchase date for requested product from a purchase history data store;
(b) comparing an elapsed time since last purchase to a user defined limit;
(c) using a household purchasing and preferences management system of claim 1 wherein the system of claim 1 is configured to disallow requests for the products that were bought within a set time period, in order to prevent unintentional duplication

8. A computer-implemented method for optimizing a shopping list comprising next steps:
resorting of an information from a shopping lists data store
further comprising transactional information about requests for products made by household members and displaying shopping list information to an user,
(a) aggregating similar products;
(b) sorting a list based on the layout of departments within a store where the said products can be found;
(c) grouping said list by said stores displaying first the store where the maximum number of products can be obtained;
(d) sequencing stores based on minimum driving time between said stores, based on the store locations.

9. A social networking and information sharing system, comprising:
(a) a module enabling members to exchange information about stores, departments and products;
(b) a import/export module for importing and exporting full stores descriptions and departmental layouts;
(c) chat rooms and bulletin boards for recommending stores and products to other household members inside or outside of the household;
(d) a ratings module for rating the stores and the products and making those ratings visible to others.
